(19) United States
(12) Patent Application Publication
(10) Pub. No.: US 2004/0258981 A1
(43) Pub. Date: Dec. 23, 2004

(54) Complete filling, self draining, liquid containing cell

(76) Inventor: John Reville Westmoreland, Duncanville, TX (US)

Correspondence Address: JOHN R WESTMORELAND, P.O. BOX 381478, DUNCANVILLE, TX, 75138, US

(21) Appl. No.: 10/465,838

(22) Filed: Jun. 20, 2003

(51) Int. Cl. H01M 2/36

(52) U.S. Cl. 429/74; 429/149

(57) ABSTRACT

A liquid holding and dispensing means in the form of outside surface walls having a thickness (3), surrounding an internal cavity. The internal cavity is connected with the outside surfaces by multiple orifices (1). The outside surface is made up of equally sized, equally spaced, multiple sided surfaces FIG. 2. Which can be but not limited to, triangular or pentagonal shapes. This enables said cells to nest closely together inside a container, yielding high volumetric densities for said cells. Complete filling and draining of said cell is accomplished by always having at least one orifice (1) of said cell at the high and low points, regardless of the orientation of the said cell. A further feature on the inside of said cell is drainage slopes (3) which prevent pooling of any liquids. Liquid runs off the walls, being channeled along the interconnecting surface grooves to the lowest orifice.

### BACKGROUND—FIELD OF INVENTION

A cell which is self draining for the outflow of the liquid contained inside of it, regardless of the orientation it is placed in. Said cell also accommodates the complete filling of liquid into it regardless of the orientation it is placed in. More than one of the said cells would be placed inside a container which is serving as a reservoir for a liquid.

### OBJECTS AND ADVANTAGES

1. A cell for holding then dispensing liquid, such as but not restricted to fuel tanks for automobiles or airplanes.

2. Being able to be filled regardless of the orientation it is placed in, due to the geometric design of the cell and location of the orifices.

3. Being able to be drained regardless of the orientation it is placed in, due to the geometric design of the cell and location of the orifices.

4. Can be retrofitted into any sized container with an opening without having to modify or disassemble the container, and without any special equipment or tools.

5. Can be installed into any sized container at the time of manufacture without any special equipment or tools.

6. If used in a application where a combustible liquid is held in a container. For example an automobile or airplane fuel tank, where a catastrophic failure of the fuel tank occurs upon impact, for example during a crash. The cells would limit the amount of fuel which is suddenly released as one mass. Said cells would be retained in the fuel tank or come out as separate small units with fuel in them. Not as one joined mass of fuel, with the potential of causing a massive fire ball.

7. When multiple said cells are placed in a container said cells are able to achieve a high volumetric density inside a container, while still retaining their ability to be self draining regardless of the orientation said cells are placed in.

Due to the cell's geometry made up of but not limited to, a four sided pyramid with equilateral triangular surfaces. For example it could be made up of multiple five sided surfaces forming a spherical shape with orifices at each corner, and still retain its ability to be self draining.

8. Cell orifice size can be varied to suit the viscosity of the liquid.

### DRAWING FIGURES

Sheet 1/2

Shows a Plan view, Front elevation, and Side elevation of a four sided hollow pyramid with the surfaces of the pyramid made up of identical equilateral triangles.

FIG. 1 shows the typical location of each of the four orifices. FIG. 1a describes the typical appearance of each of the four orifices.

Sheet 2/2

FIG. 3 shows a section cut through the center, showing the wall of the hollow pyramid as called out in the Plan view on Sheet 1/1.

### REFERENCE NUMERALS IN DRAWINGS

1 Orifice

2 Drainage Slope Location

3 Drainage Slope

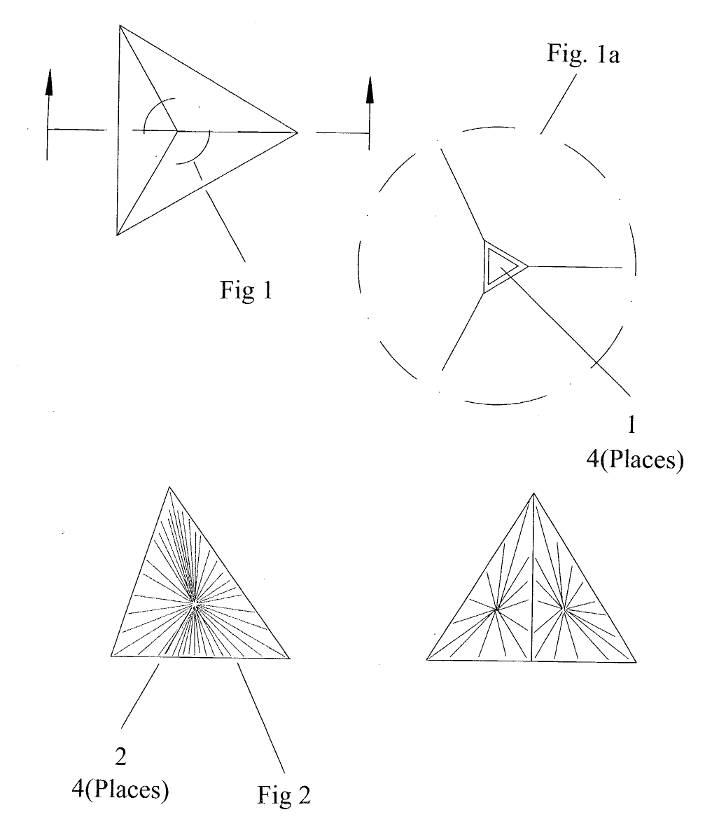

### DESCRIPTION—FIGS. 1, 2, 3

An orifice connecting the exterior of the cell to the interior, located in FIG. 1 (Plan View) and depicted in FIG. 1a is typical at all extremities of the cell. It can be of the shape depicted or any other shape suitable to its performance requirements.

The location of the drainage slope is shown in FIG. 2. This is typical on all surfaces of a pyramid or any other geometric shape used to make up a cell.

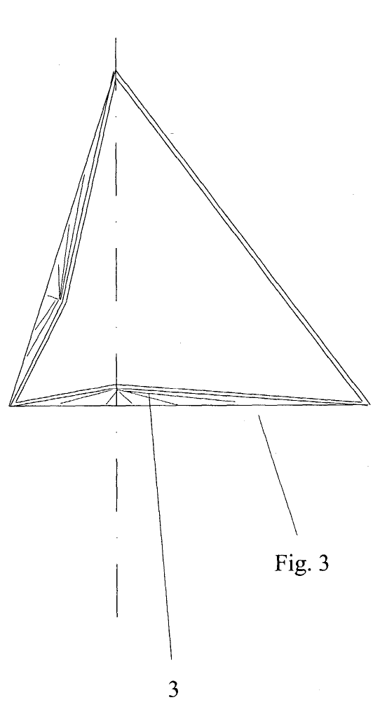

The location of the drainage slope is further shown in FIG. 3, as is the relationship of the interior surfaces to the exterior surfaces of the hollow cell.

### OPERATION—FIGS. 1, 2, 3

A cell is a hollow object, with the exterior surfaces being connected to the interior surfaces by orifices at the extremities (corners). With more than one cell being placed into a liquid storing container. The orifices shown in FIG. 1a serve multiple purposes, 1). allow liquid to enter said cell at the same time gas is expelled from said cell, 2). allow liquid to exit said cell at the same time gas is drawn into said cell. The orifices are placed at the extremities (corners) of said cell to allow complete draining and eliminate pooling of the liquid inside said cell.

As a means for ensuring complete emptying of a cell, a drainage slope FIG. 2 is located on each of the surfaces making up said cells geometry.

The shape of the drainage slope is shown in FIG. 3. As can be seen by the location of said drainage slope in FIG. 2. and the geometry of the said drainage slope in FIG. 3., it shows how liquid inside will be guided into the channels formed by the joining of said cells different surfaces. This in turn guides the liquid to the lowest orifice completely draining said cell.

This invention can be easily placed inside any container, new or existing, with an opening only slightly larger than a cell itself. This can be accomplished by placing said cells in the container by hand or mechanically placing said cells into the container.

A cell can be produced in any size and orifice opening size desired or needed to suit the liquid stored and flow rate required, limited only by manufacturing capabilities.

Cells can be mass produced at a very low cost with existing technology, such as but not limited to “plastic blow-molding.”

If liquid storage requirements change, such as but not limited to a change in viscosity, cells can be removed and replaced at any time in any local in any sized container.

Removal of cells from a container is accomplished easily, either by use of a mechanical means or placing a port in the container in a bottom position and allowing cells to fall out.

In the case of a catastrophic failure of a fuel container holding these cells, only the residual fuel in the bottom of the tank is available for immediate combustion. With the remainder of the fuel only being available for combustion as it drains from said cells. This would not be the case with a fuel holding container without cells inside it. In a catastrophic failure the entire contents of this container will spill out and be available for immediate combustion.

No special equipment, tools or training is needed to use, install or remove cells from any kind of container.

### SUMMARY OF THE INVENTION

Although the above describes several specifications, they should not be construed as limiting the scope of the invention but as merely providing illustrations of some of the preferred embodiments of this invention. For example the triangular shaped side of a cell can take on a different shape, such as but not limited to a pentagonal shaped side.

Thus the scope of the invention should be determined by the appended claims and their legal equivalents, rather than by the examples given.

I claim:

1). Complete filling and self draining of a cell is caused by multiple orifices connecting the inside surface of said cell with the outside surface of said cell. The geometric shape of the inside and outside surfaces of said cell assure at least one orifice being the high point and one orifice being the low point, no matter what orientation said cell is placed in.

2). Inside a cell are drainage slopes on each wall surface of said cell. Multiple drainage slopes cause the liquid to run off the sides and be channeled towards the lowest orifice.

3). The outside geometry of a cell has multiple surfaces of equal proportions equally spaced around the outside surface of the said cell. This allows for nesting of the cells together, giving a high volumetric density of said cells inside a container.

4). Multiple cells nested together inside a container break the liquid up into many single components, preventing the liquid from behaving with a single inertia.
